(19) United States
(12) Patent Application Publication
(10) Pub. No.: US 2023/0015919 A1
(43) Pub. Date: Jan. 19, 2023

(54) TORQUE-LIMITING FASTENER AND COUPLING

(71) Applicant: BrassCraft Manufacturing Company, Novi, MI (US)

(72) Inventor: Jeffrey T. Root, Howell, MI (US)

(21) Appl. No.: 17/858,313

(22) Filed: Jul. 6, 2022

Related U.S. Application Data
(60) Provisional application No. 63/221,650, filed on Jul. 14, 2021.

(51) Int. Cl. F16D 7/00; F16L 15/08

(52) U.S. Cl. CPC F16D 7/00; F16L 15/08

(57) ABSTRACT

A torque-limiting fastener and a method of assembling the same includes a drive shell, a driven fastener carried by the drive shell, and a clutch axially between the fastener and the drive shell. The drive shell may have a shell base wall including drive-off surfaces, drive-on surfaces, and a shell skirt extending axially away from the shell base wall. The driven fastener may have a fastener base wall including driven-on surfaces, driven-off surfaces, drive tang pockets between the driven-on and driven-off surfaces, and driven-on beam pockets, and a radially outer wall extending in an axial direction away from the fastener base wall. The clutch may have a plate, a driven beam, and a driven tang, wherein the driven beam and the drive tang are cantilevered with respect to the plate. A drive shell, driven fastener, and clutch are individually disclosed.

### TECHNICAL FIELD

This disclosure relates generally to fasteners and, more particularly, to torque-limiting fasteners.

### BACKGROUND

Fasteners, such as nuts and bolts, are ubiquitous in industry. And some fasteners are adapted for use with rotatable couplings, which are used for coupling pipes, tubes, electrical components, and various other products for various applications. In a general plumbing example, a fluid connector includes a tube with an open end, a barbed connector with a barbed cylinder interference fit in the open end of the tube and a seal flange extending radially outwardly from the cylinder. The fluid connector also includes a ferrule crimped around the open end of the tube to the barbed connector, and a threaded nut having a base wall trapped between the ferrule and the seal flange of the barbed connector and a skirt extending away from the base wall and having interior threads for threading to another component to which the tube is to be coupled.

In a plumbing example, a torque-limiting fluid coupling includes a nut assembly including a plastic nut having radially outwardly extending driven lugs axially extending over a significant length of the nut and a plastic outer shell rotatably carried around the nut and having radially inwardly extending drive lugs axially extending over a significant length of the outer shell for driving the driven lugs of the nut. The driven and drive lugs have cooperating blunt surfaces that engage one another when the outer shell is rotated in a counterclockwise direction to decouple the nut from another component. Likewise, the driven and drive lugs also have cooperating cam surfaces that engage one another when the outer shell is rotated in a clockwise direction to fasten the nut to the other component. As the outer shell is rotated clockwise, the cam surfaces of the drive lugs initially stay in contact with the corresponding cam surfaces of the driven lugs to torque down the nut to the other component to a desired torque load. But once the desired torque load is reached, the drive lugs will deflect radially outwardly and thereby skip over the driven lugs such that the outer shell will rotate with respect to the nut, thereby limiting the torque load that can be applied through the nut assembly to prevent overtightening of the nut assembly. Such torque-limiting fluid couplings exhibit a very limited coupling removal torque that is only about two to three times that of a coupling install torque. Accordingly, when a user attempts to decouple the nut by rotating the outer shell counterclockwise, the drive lugs may deform and fail to suitably engage the driven lugs such that the nut assembly cannot be removed by hand. Likewise, the lugs may deform rapidly over just a few install and removal cycles such that the torque carrying capacity of the lugs may degrade about 1 Nm over seven install and removal cycles.

### SUMMARY

A torque-limiting fastener comprising a drive shell including a shell base wall having drive-off surfaces on an interior side of the shell base wall and facing a first circumferential direction. The shell base wall further includes drive-on surfaces on the interior side of the shell base wall and facing a second circumferential direction. The torque-limiting fastener further includes a shell skirt extending axially away from the shell base wall. The torque-limiting fastener further includes a driven fastener carried by the drive shell. The driven fastener includes a fastener base wall having driven-on surfaces on an exterior side of the fastener base wall and facing the first circumferential direction and driven-off surfaces on an exterior side of the fastener base wall and facing the second circumferential direction. The driven fastener further includes a radially outer wall extending axially away from the fastener base wall. The torque limiting fastener further includes a clutch axially between the fastener and shell base walls. The clutch includes a plate, a driven beam extending radially outwardly and cantilevered with respect to the plate and having a leg extending circumferentially and a foot extending circumferentially and axially inwardly at an oblique angle, and a drive tang extending radially and axially outward with respect to the plate.

A torque-limiting drive shell comprising a shell base wall having drive-off surfaces on an interior side of the shell base wall and facing a first circumferential direction and extending substantially axially. The shell base wall further includes drive-on surfaces on an interior side of the shell base wall and facing a second circumferential direction and extending substantially obliquely. The torque-limiting drive shell further includes a shell skirt extending axially away from the shell base wall.

A torque-limiting driven fastener comprising a fastener base wall including driven-on surfaces on an exterior side of the fastener base wall and facing in a first circumferential direction. The fastener base wall further includes driven-off surfaces on an exterior side of the fastener base wall and facing in a second circumferential direction. The fastener base wall further includes drive tang pockets on an exterior side of the fastener base wall and circumferentially between the exterior driven-on and driven-off surfaces. The fastener base wall further includes driven-on beam pockets on an exterior side of the fastener base wall and circumferentially interspersed with the drive tang pockets. The torque-limiting driven fastener further includes a radially outer wall extending in an axial direction away from the fastener base wall.

A torque-limiting clutch comprising a plate and driven beams extending radially outwardly and cantilevered with respect to the plate. The driven beams having legs extending circumferentially and feet extending circumferentially and axially inwardly at an oblique angle. The torque-limiting clutch further includes drive tangs extending radially and axially outwardly with respect to the plate.

A method for a nested assembly of a torque-limiting fastener comprising providing a barb and seal hose connector having a rearward end, a forward end having a neck and a flare extending about the neck, the flare defining a contact surface, and a longitudinal axis extending between the rearward and forward ends. The method further comprising positioning a driven fastener over the forward end of the barb and seal hose connector, the driven fastener having an internal shoulder which engages with the contact surface of the flare, the driven fastener having a base wall including a drive-tang pocket, a driven-on beam pocket, and a hub. The method further comprising positioning a clutch over the forward end of the barb and seal hose connector, the clutch having a driven beam and a drive tang that engage with at least one of each of the drive-tang pocket and the driven-on beam pocket. The method further comprising positioning a drive shell over the forward end of the barb and seal hose connector and assembling a hose to the barb and seal hose connector.

### BRIEF DESCRIPTION OF THE DRAWINGS

FIG. 1 is a perspective view according to an illustrative embodiment of a torque-limiting nut as applied to a plumbing product including a braided hose, a barb and seal hose connector, and a ferrule crimped around the braided hose to the connector;

FIG. 2 is an exploded perspective view of the plumbing product having the torque-limiting nut of FIG. 1;

FIG. 3 is an exploded perspective view of the torque-limiting nut of FIGS. 1 and 2, including a drive shell, a driven nut, and a clutch therebetween;

FIG. 4 is a perspective view of the driven nut of FIG. 3, illustrated upside down relative to how the driven nut is illustrated in FIG. 3;

FIG. 5 is a fragmentary perspective view of the torque-limiting nut of FIG. 3, illustrating the drive shell being rotated clockwise to engage the clutch, which, in turn, rotates to engage the driven nut, and wherein a driven beam of the clutch is schematically illustrated in a deflected torque-limiting position;

FIG. 6 is a fragmentary perspective view of the torque-limiting nut of FIG. 3, illustrating the drive shell being rotated clockwise to engage the clutch, which, in turn, rotates to engage the driven nut, and wherein the driven beam of the clutch is schematically illustrated in a deflected torque-limiting position, and a drive tang of the clutch is illustrated in a drive-on position;

FIG. 7 is a fragmentary perspective view of the torque-limiting nut of FIG. 3, showing the drive shell removed, wherein the driven beam of the clutch is schematically illustrated in the deflected torque-limiting position, and the drive tang is illustrated in the drive-on position;

FIG. 8 is a schematic view of the torque-limiting nut of FIG. 3, illustrating the drive shell being rotated to engage the clutch, which, in turn, rotates to engage and drive the driven nut clockwise;

FIG. 9 is a schematic view of the torque-limiting nut of FIG. 3, illustrating the driven beam of the clutch in a deflected torque-limiting position, and the drive tang in contact with the driven nut;

FIG. 10 is a fragmentary perspective view of the torque-limiting nut of FIG. 3, illustrating the drive shell being rotated counterclockwise to engage the clutch, which, in turn, rotates counterclockwise to engage the driven nut;

FIG. 11 is a fragmentary perspective view of the torque-limiting nut of FIG. 3, illustrating the drive shell being rotated counterclockwise to engage the clutch, which, in turn, rotates to engage the driven nut, and wherein the drive tang is illustrated in a drive-off position;

FIG. 12 is a fragmentary perspective view of the torque-limiting nut of FIG. 3, showing the drive shell removed, wherein the driven beam of the clutch is illustrated in a stiff beam position, and the drive tang is illustrated in the drive-on position;

FIG. 13 is a schematic view of the torque-limiting nut of FIG. 3, illustrating the drive shell being rotated counterclockwise to engage the clutch, which, in turn, rotates counterclockwise to engage and drive the driven nut counterclockwise;

FIG. 14 is a perspective view of a torque-limiting nut according to another embodiment;

FIG. 15 is a cross-sectional perspective view of the torque-limiting nut of FIG. 14, illustrating a drive shell according to another embodiment and including a body and a cap, a driven nut according to another embodiment, and the clutch;

FIG. 16 is an exploded perspective view of the torque-limiting nut of FIG. 15, illustrating the drive shell, the driven nut, and the clutch;

FIG. 17 is a perspective view of a torque-limiting nut according to another embodiment;

FIG. 18 is a cross-sectional perspective view of the torque-limiting nut of FIG. 17, illustrating the drive shell, a driven nut according to another embodiment, and the clutch;

FIG. 19 is an exploded perspective view of the torque-limiting nut of FIG. 18, illustrating the drive shell, the driven nut, and the clutch;

FIG. 20 is partial cross-sectional view according to an illustrative embodiment of a torque-limiting nut as applied to a plumbing product including a braided hose, a barb and seal hose connector, and a ferrule crimped around the braided hose to the connector;

FIG. 21 is perspective view of a clutch or spring plate of FIG. 20;

FIG. 22 is an exploded perspective view of a plumbing product according to a further embodiment and illustrates a barb assembly, a driven nut of a first size, a clutch, a drive shell, a ferrule and a braided hose;

FIG. 23 is a fragmentary perspective view of the plumbing product of FIG. 22 illustrating an auxiliary rim and knurling;

FIG. 24 is a fragmentary perspective view of the plumbing product of FIG. 22 illustrating a portion of a barb trapping the driven nut within the outer shell;

FIG. 25 is a fragmentary perspective view of the plumbing product of FIG. 22 illustrating the driven nut axially extending beyond the axial extent of the outer shell;

FIG. 26 is an exploded perspective view of a plumbing product according to a further embodiment and illustrates the barb assembly, the driven nut of a second size, the clutch, the drive shell, the ferrule and the braided hose;

FIG. 27 is a fragmentary perspective view of the plumbing product of FIG. 26 illustrating an auxiliary rim and knurling;

FIG. 28 is a fragmentary perspective view of the plumbing product of FIG. 26 illustrating a portion of a barb trapping the driven nut within the outer shell;

FIGS. 29a-29f are perspective views of a nested assembly of a plumbing product; and

FIG. 30a-30f are cross-sectional views of the nested assembly of a plumbing product of FIGS. 29a-29f.

### DETAILED DESCRIPTION

In general, a torque-limiting nut will be described using one or more examples of illustrative embodiments of a plumbing product such as a faucet or toilet connector. The example embodiments will be described with reference to use in the plumbing industry. However, it will be appreciated as the description proceeds that the claimed subject matter is useful in many different applications and may be implemented in many other embodiments. In this regard, and as used herein and in the claims, it will be understood that the claimed torque-limiting nut refers not only to plumbing applications, but also to other applications, including electrical connectors, medical device connectors, and any other applications suitable for use with a torque-limiting nut, or even a torque-limiting bolt.

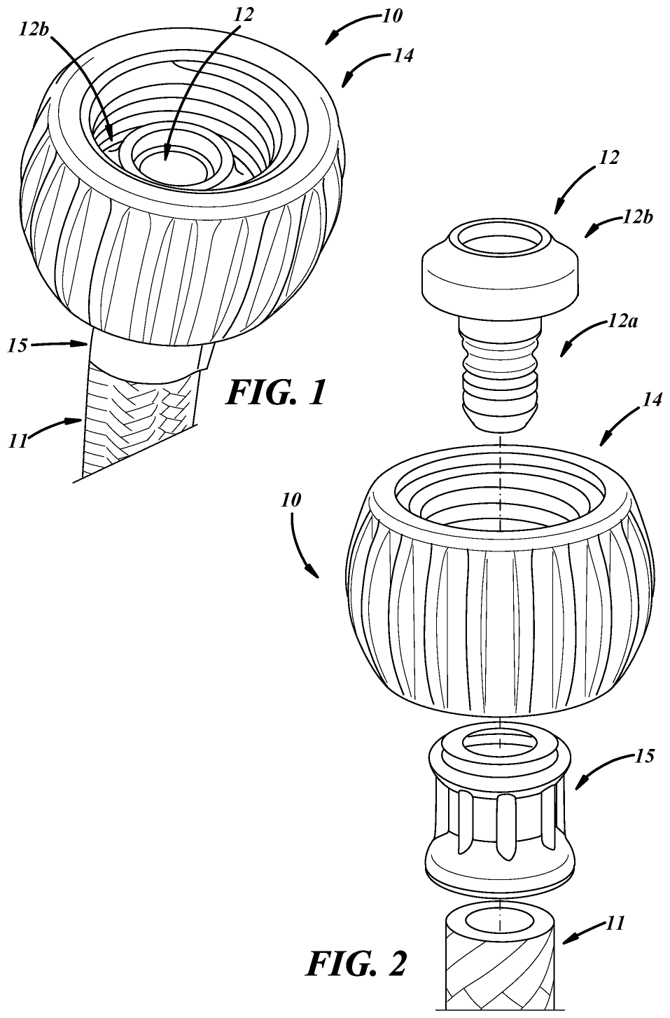

Referring specifically to the drawings, FIGS. 1 and 2 show an illustrative embodiment of a plumbing product 10 including a braided hose 11, a barb and seal hose connector 12 including a barb 12a and a seal 12b coupled to the barb 12a (FIG. 2), a torque-limiting nut 14 trapped between the braided hose 11 and the barb and seal hose connector 12 (FIG. 2), and a ferrule 15 crimped around the braided hose 11 to the connector 12 (FIG. 2). As will be described in greater detail below, the torque-limiting nut 14 includes a novel arrangement of features that may provide improved functionality and durability compared to prior torque-limiting nuts.

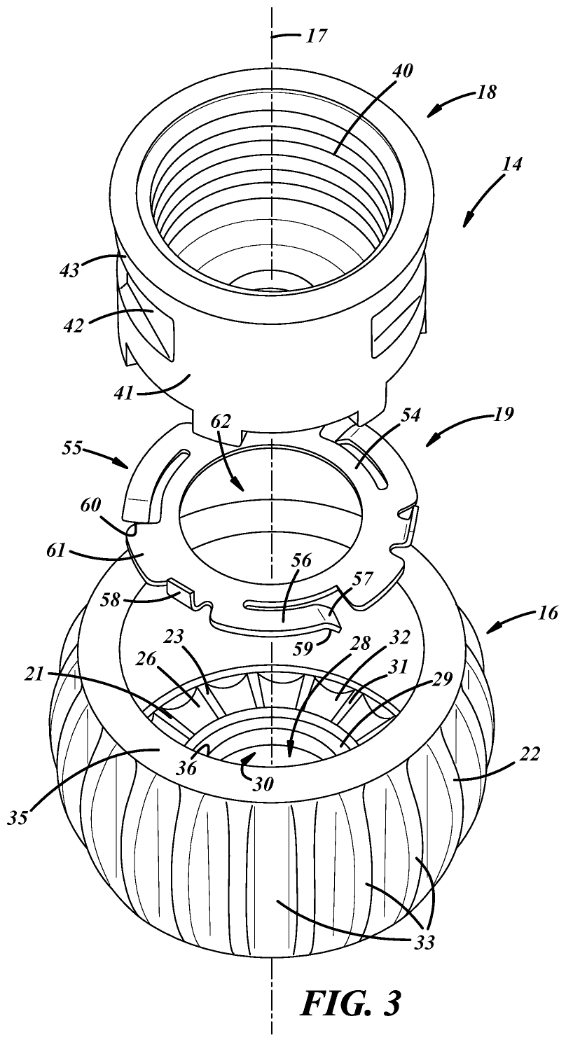

With reference to FIG. 3, the torque-limiting nut 14 includes a drive shell 16 rotatable about a central longitudinal axis 17, a driven nut 18 configured to be carried in the drive shell 16, and a spring plate or clutch 19 configured to be axially located between the drive shell 16 and the driven nut 18. As will be described in greater detail below, the nut 18 may be a lost motion assembly wherein the clutch 19 may be configured to cooperate with the drive shell 16 and the driven nut 18 to provide a rotational delay between rotation of the drive shell 16 and rotation of the driven nut 18 and facilitate repositioning of the clutch 19 relative to the driven nut 18 to allow the clutch 19 to carry greater torque.

The drive shell 16, with continued reference to FIG. 3, may be of any suitable construction and composition. For example, the drive shell 16 may be molded from polymeric material, for instance, polypropylene or glass filled polypropylene. Or, the drive shell 16 may be manufactured from any other material and in any other manner suitable for use with torque-limiting nuts.

In any case, the drive shell 16 carries the driven nut 18 and basically includes a shell base wall 21, and a shell skirt 22 extending axially away from the shell base wall 21. The shell base wall 21 has drive-off surfaces 23 on an interior side of the shell base wall 21 and facing a first or drive-off circumferential direction, and drive-on surfaces 26 on the interior side of the shell base wall 21 and facing a second or drive-on circumferential direction that may be circumferentially opposite that of the first circumferential direction. For embodiments involving passage of a hose, tube, pipe, wire, cable, or any other suitable component(s) through the shell 16, the shell base wall 21 may include a shell aperture 28, wherein the drive-off and drive-on surfaces 23, 26 circumscribe the shell aperture 28. In this case, the drive shell 16 also may include a hub 29 extending axially inwardly from the base wall 21 and establishing the shell 16 aperture 28 via an internal diameter of the hub 29. In other embodiments, such as a cap nut (not shown), no aperture is needed.

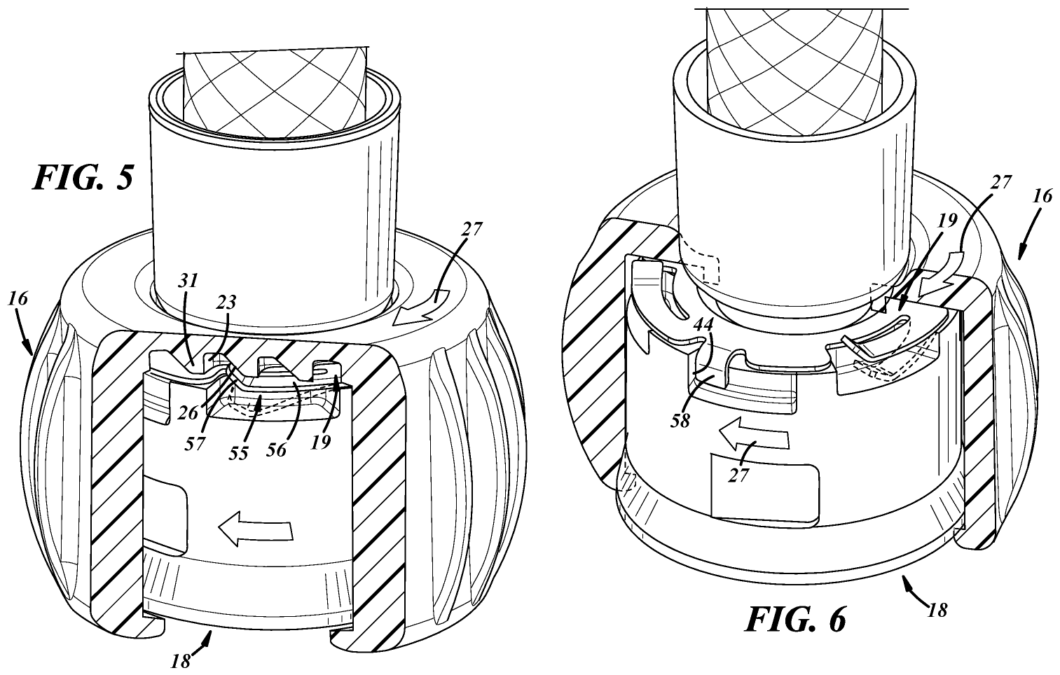

With reference to FIGS. 3 and 5, the shell drive-off surfaces 23 may extend substantially axially (e.g., within −3 to +4 degrees with respect to the longitudinal axis 17, including all ranges, sub-ranges, endpoints, and values in that range) and radially, and the drive shell 16 drive-on surfaces 26 may extend substantially obliquely (e.g., within 30 to 70 degrees with respect to the longitudinal axis 17, including all ranges, sub-ranges, endpoints, and values in that range). The drive-off and drive-on surfaces 23, 26 may be established by lugs 31. The lugs 31 may project axially inwardly from the shell base wall 21, extend radially between the hub 29 and the skirt 22, and may be provided in a circumferential array. The array of lugs 31 may establish an array of pockets 32 therebetween, which may be located radially between the hub 29 and the skirt 22. The arrays may include, for example, 10 to 30 of each lugs 31 and pockets 32.

Also, with reference to FIG. 3, the drive shell skirt 22 may include knurling 33 on an exterior thereof, for example, for enhanced grip by a user. Notably, in contrast to prior torque-limiting nuts, the shell skirt 22 does not include internal radial drive elements carried thereon, such as radially inwardly projecting drive lugs. Additionally, at or proximate an axial end 35 of the drive shell 16, the drive shell skirt 22 may terminate in a radially inwardly extending lip 36. Those of ordinary skill in the art will recognize that the lip 36 may be produced by undercut molding, wherein an annular groove on an expandible mold core may be used as an undercut to define the lip 36. In any case, the lip 36 may be provided to axially trap the driven nut 18 between the base wall 21 and the lip 36.

The driven nut 18, with continued reference to FIG. 3, may be of any suitable construction and composition. For example, the driven nut 18 may be molded from polymeric material, for instance, glass filled polypropylene. Or, the driven nut 18 may be manufactured from any other material and in any other manner suitable for use with torque-limiting nuts.

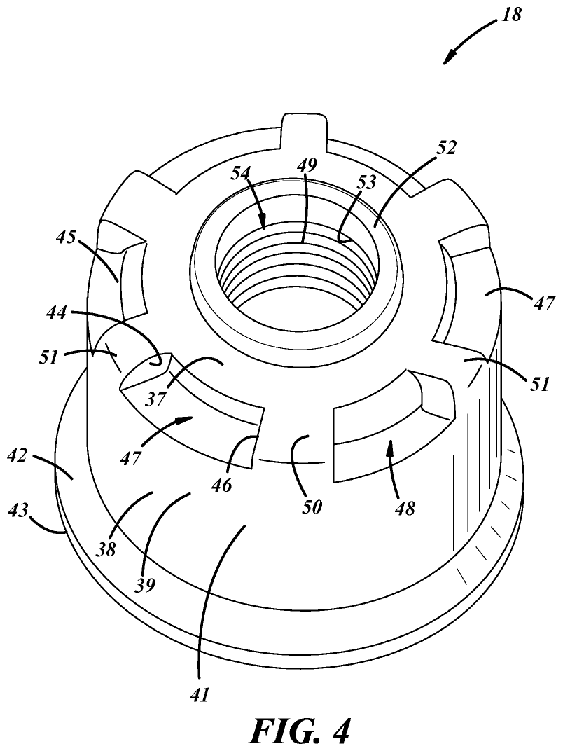

With additional reference to FIG. 4, the driven nut 18 includes a base wall 37, and a radially outer wall 38 extending axially away from the base wall 37. In this embodiment, the radially outer wall 38 is a skirt 39 that extends integrally from the base wall 37 and carries an internal thread 40. As used herein, the term “thread” includes one or more threads or thread segments. In any case, the skirt 39 may have a substantially cylindrical body 41 and may terminate in a reverse-tapered surface 42 that terminates in an external shoulder 43. In assembly to the drive shell 16, the reverse-tapered surface 42 slightly stretches the lip 36 of the skirt 22 of the drive shell 16 until the lip 36 snaps behind the external shoulder 43 of the skirt 22 of the driven nut 18 to axially retain the driven nut 18 to the drive shell 16. Notably, in contrast to prior torque-limiting nuts, the driven nut 18 does not include external radial driven elements carried thereon, such as radially outwardly projecting driven lugs.

The nut base wall 37 includes driven-on surfaces 44 on an exterior side of the nut base wall 37 and facing in the first circumferential direction, and driven-off surfaces 46 on the exterior side of the nut base wall 37 and facing in the second circumferential direction. The driven nut 18 also includes drive tang pockets 47 on the exterior side of the nut base wall 37 and circumferentially between the exterior driven-on and driven-off surfaces 44, 46 and driven-on beam pockets 48 on the exterior side of the nut base wall 37 and circumferentially interspersed with the drive tang pockets 47. For embodiments involving passage of a hose, tube, pipe, wire, cable, or any other suitable component(s) through the driven nut 18, the nut base wall 37 has a nut aperture 49, wherein the driven-on and driven-off surfaces 44, 46 circumscribe the nut aperture 49. In other embodiments, such as a cap nut (not shown), no aperture is needed.

The nut base wall 37 may include clutch flange support lugs 50 being located between the drive tang pockets 47 and driven-on beam pockets 48 and establishing the driven-off surfaces 46. Likewise, the base wall 37 may include clutch driven-on beam support lugs 51 being located between the drive tang pockets 47 and driven-on beam pockets 48 and establishing the driven-on surfaces 44. The clutch driven-on beam support lugs 51 may be circumferentially wider than the clutch flange support lugs 50. Likewise, the drive tang pockets 47 may be axially deeper than the driven-on beam pockets 48. The quantities of each of the pockets 47, 48 and lugs 50, 51 may be three as shown, or more or less, depending on requirements of any particular application. Finally, the drive nut 18 also may include a hub 52 extending axially outwardly from the base wall 37 and establishing the nut aperture 49 via an internal diameter 54 of the hub 52.

The clutch 19, with continued reference to FIG. 3, may be of any suitable construction and composition. For example, the clutch 19 may be stamped from metal, for instance, stainless steel, for example, 301 stainless steel that may be stamped using fineblank or Gripflow types of process and then may be partially or fully heat treated and may comply with ASTM A240. Or, the clutch 19 may be manufactured from any other material and in any other manner suitable for use with torque-limiting nuts.

In any case, the clutch 19 includes a plate 54, driven beams 55 extending radially outwardly and cantilevered with respect to the plate 54 and having legs 56 extending circumferentially and feet 57 extending circumferentially and axially inwardly at an oblique angle, and drive tangs 58 extending radially and axially outwardly with respect to the plate 54. The feet 57 have drive-on surfaces 59 extending at an obtuse angle and drive-off 60 surfaces extending at an acute angle with respect to a plane of the plate 54 that extends transversely with respect to the longitudinal axis 17. The clutch 19 also may include support flanges 61 extending radially outwardly of the plate 54 and circumferentially between the drive tangs 58 and the driven beams 55. For embodiments involving passage of a hose, tube, pipe, wire, cable, or any other suitable component(s) through the clutch 19, the clutch 19 has an aperture 62 therethrough, wherein the driven beams 55 and the drive tangs 58 circumscribe the aperture 62. In other embodiments, such as a cap nut (not shown), no aperture is needed.

The drive tangs 58 may extend circumferentially between 2 and 10 angular degrees including all ranges, sub-ranges, endpoints, and values in that range. The driven beams 55 may extend circumferentially between 10 and 30 angular degrees including all ranges, sub-ranges, endpoints, and values in that range. The feet 57 of the driven beams 55 may extend at an oblique angle with respect to the legs 56 of the driven beams 55 between 20 and 70 angular degrees including all ranges, sub-ranges, endpoints, and values in that range.

With reference now to FIG. 5, rotation of the drive shell 16 in a clockwise/drive-on direction 27 (as shown schematically by an arrow in FIGS. 5-9) results in the drive-on surface 26 of the drive shell 16 engaging a corresponding foot 57 of a driven beam 55 of the clutch 19.

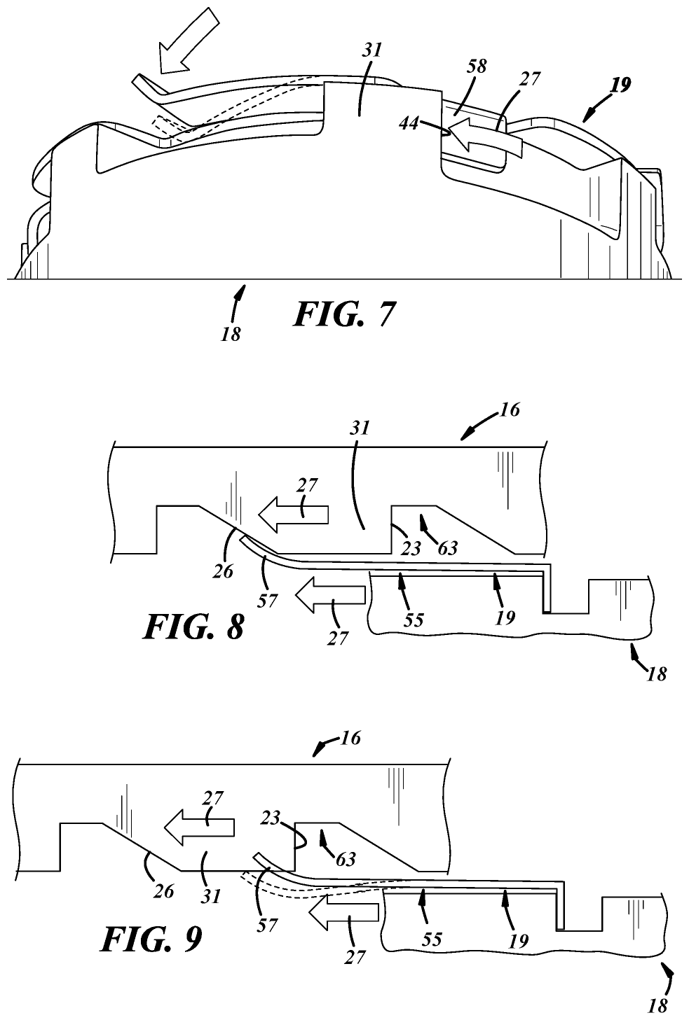

With reference to FIGS. 6 and 7, continued rotation of the drive shell 16 in the clockwise direction 27 results in rotation of the clutch 19 in a clockwise direction 27 until a drive tang 58 of the clutch 19 engages the drive-on surface 44 of the driven nut 18.

With reference to FIG. 8, further rotation of the drive shell 16 in the clockwise direction 27 results in rotation of the driven nut 18 in a clockwise direction 27. Once a maximum torque limit is reached, even further rotation of the drive shell 16 in the clockwise direction 27 results in overrunning of the drive shell 16 relative to the driven nut 18. More specifically, the result is deflection of the driven beam 55 of the clutch 19 by the drive shell 16 (as shown schematically in FIGS. 5-7 and 9) and passage of the drive-on surface 26 of the drive shell 16 past the foot 57 of the driven beam 55 of the clutch 19 such that the beam 55 snaps back against an undersurface of the drive shell 16 to create audible and/or tactile feedback to the user that the torque limit has been reached.

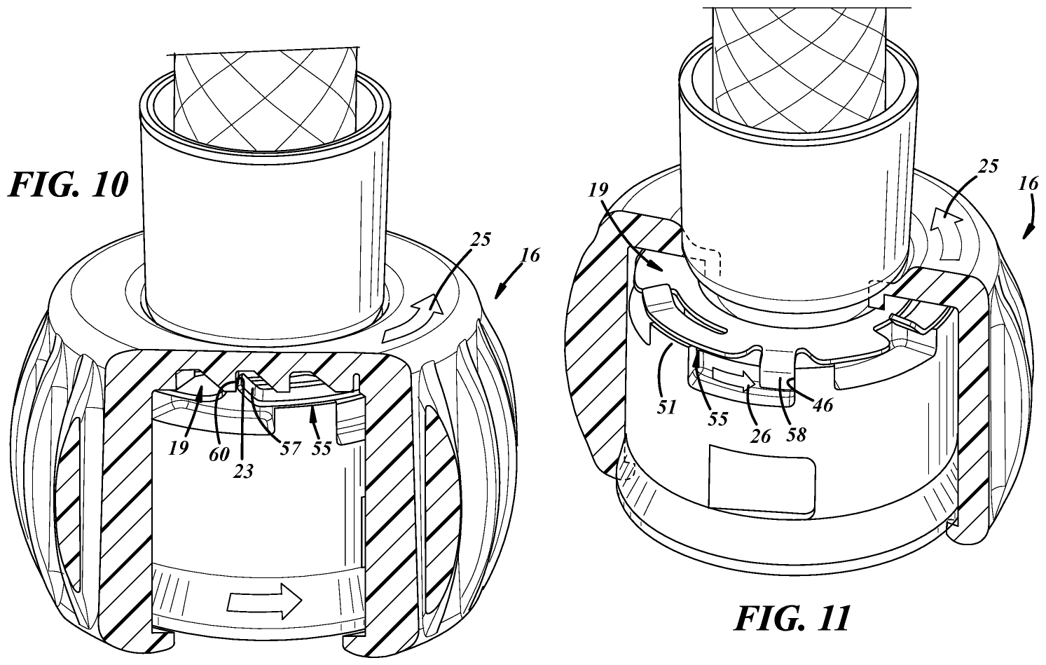

With reference now to FIG. 10, rotation of the drive shell 16 in a counterclockwise/drive-off direction 25 (as shown schematically by an arrow in FIGS. 10-13) results in the drive-off surface 23 of the drive shell 16 engaging the drive-off surface 60 of a corresponding foot 57 of a driven beam 55 of the clutch 19.

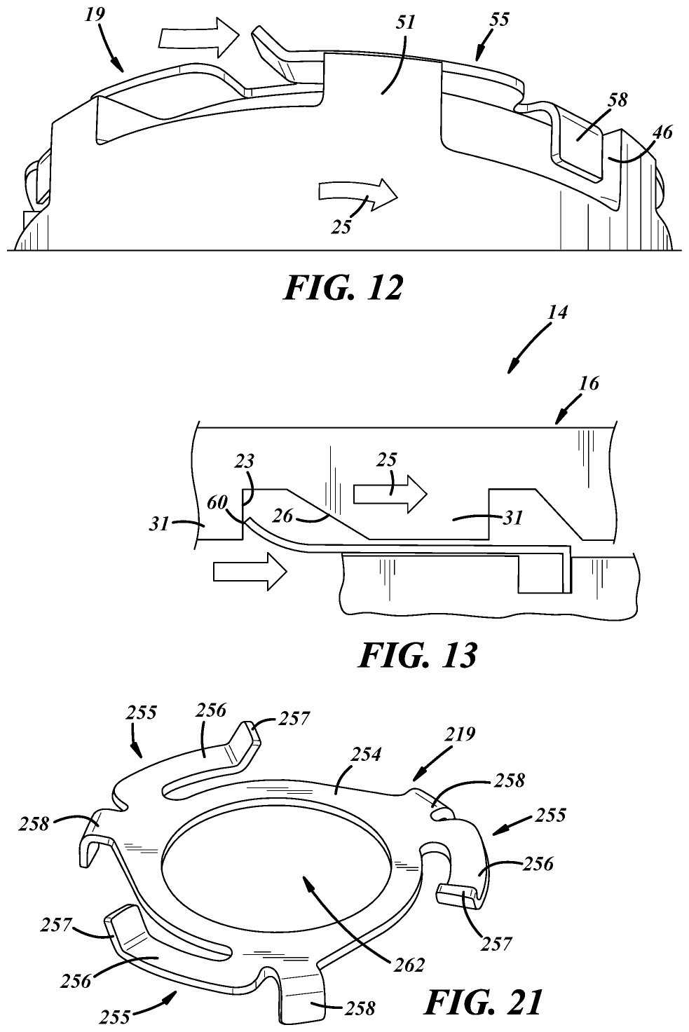

With reference to FIGS. 11 and 12, continued rotation of the drive shell 16 in the counterclockwise direction 25 results in rotation of the clutch 19 in a counterclockwise direction 25 until a drive tang 58 of the clutch 19 engages the drive-off surface 46 of the driven nut 18. Such rotation of the clutch 19 results in the driven beam 55 of the clutch 19 supported on the corresponding driven beam 55 support lug 51 such that the beam 55 has a shorter fulcrum such that the beam 55 is trapped between the support lug 51 and the drive shell 16 to provide a stiffer beam to allow the beam 55 to carry more torque without bending.

With reference to FIG. 13, further rotation of the drive shell 16 in the counterclockwise direction 25 results in rotation of the driven nut 18 until the torque-limiting nut 14 is removed from whatever it is coupled to.

In the illustrated embodiment, the clutch 19 includes three circumferentially equidistantly spaced legs 56 and the drive shell 16 includes 21 corresponding circumferentially equidistantly spaced pockets 32, to result in a detent “click” for every 17.14 degrees of rotation of the outer drive shell 16 once the breakaway torque limit is reached. Those of ordinary skill in the art would recognize that other quantities of clutch legs 56 (e.g., 4, 5, 6, or any other suitable quantity) could be used with any other quantities of corresponding drive shell 16 pockets 32 to obtain desired functionality. Notably, all three legs 56 engage and release the drive shell 16 simultaneously so that reaction forces on the clutch 19 are symmetrical about the axis of rotation 17 so that the clutch 19 does not tend to tip out of plane. Moreover, the clutch legs 56 may be configured to be thin enough and long enough such that tips of the feet 57 can deflect about 10 to 20 percent (including all ranges, sub-ranges, endpoints, and values in that range) more than the vertical/axial length of the feet 57, at least 100 times without damage. Preferably, the length of the legs is 8 to 14 times greater (including all ranges, sub-ranges, endpoints, and values in that range) than the plate thickness of the legs for clutches having a plate thickness under 0.030″. For example, the illustrated clutch 19 has a plate thickness of 0.024″ with legs 56 that are 0.23″ long and with feet 57 that are 0.057″ long and bent at a 60 degree angle, which means the leg 56 deflects 0.049″ (sin 60×0.057″) to jump from one detent pocket 32 to the next. The relatively long and thin clutch legs 56 provide consistent installation torques but would not enable very large removal torques without incurring damage if the clutch 19 did not rotate to shorten the leg length during removal rotation.

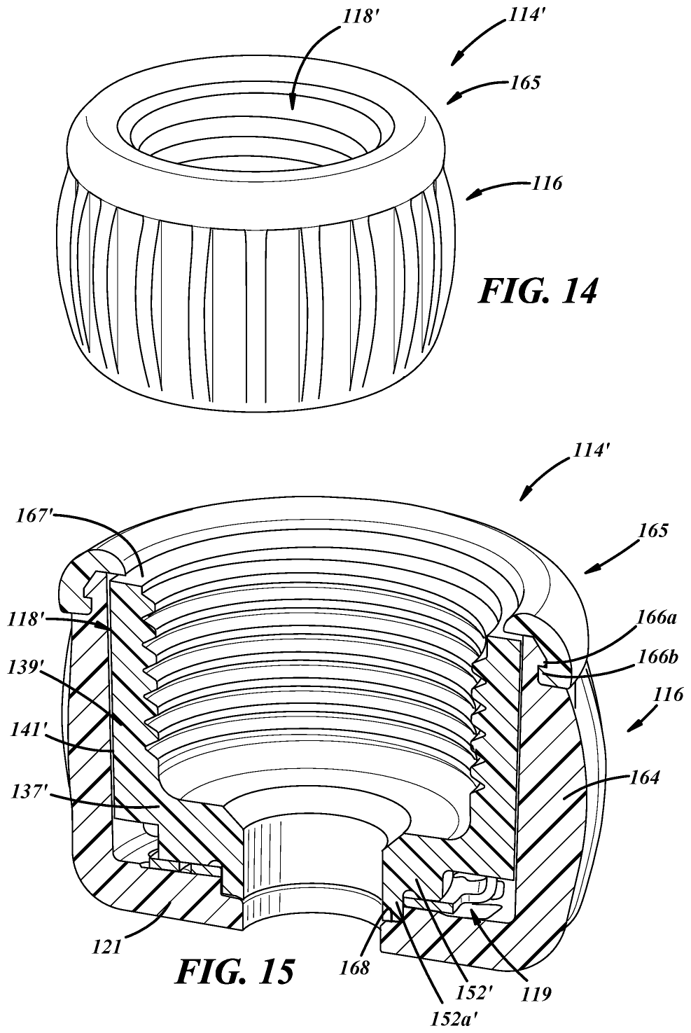

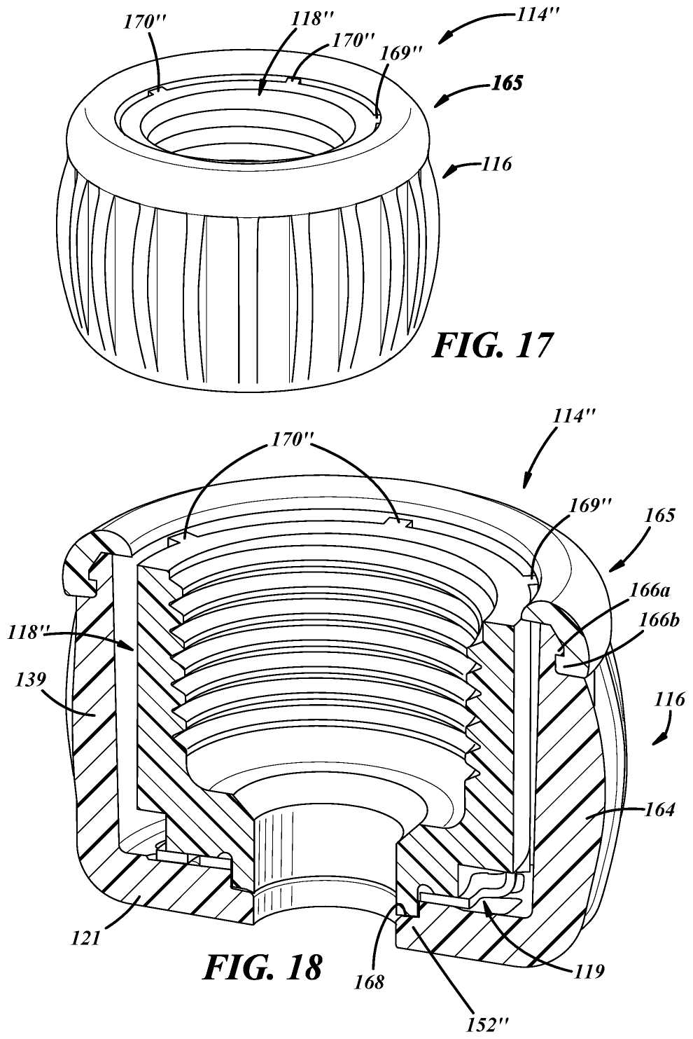

FIGS. 14-19 illustrate another illustrative embodiment of torque-limiting nuts 114′, 114″ adapted for use with differently sized driven nuts 118′, 118″. This embodiment is similar in many respects to the embodiment of FIGS. 1-13 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIGS. 15 and 18, the torque-limiting nuts 114′, 114″ include a drive shell 116 including a body 164 and a cap 165, interchangeable driven nuts 118′, 118″ carried by the drive shell 116 between the body 164 and the cap 165, and a clutch 119. The drive shell 116 may include a base wall 121, a skirt 122 extending from the base wall 121, and the cap 165 may be snap fit to the body 164 of the drive shell 116 via interengaging annular features such as the bayonet-style features 166a, 166b illustrated in FIGS. 15 and 18. Or, the cap 165 may be removably coupled to the body 164 via cooperating threads, or the like.

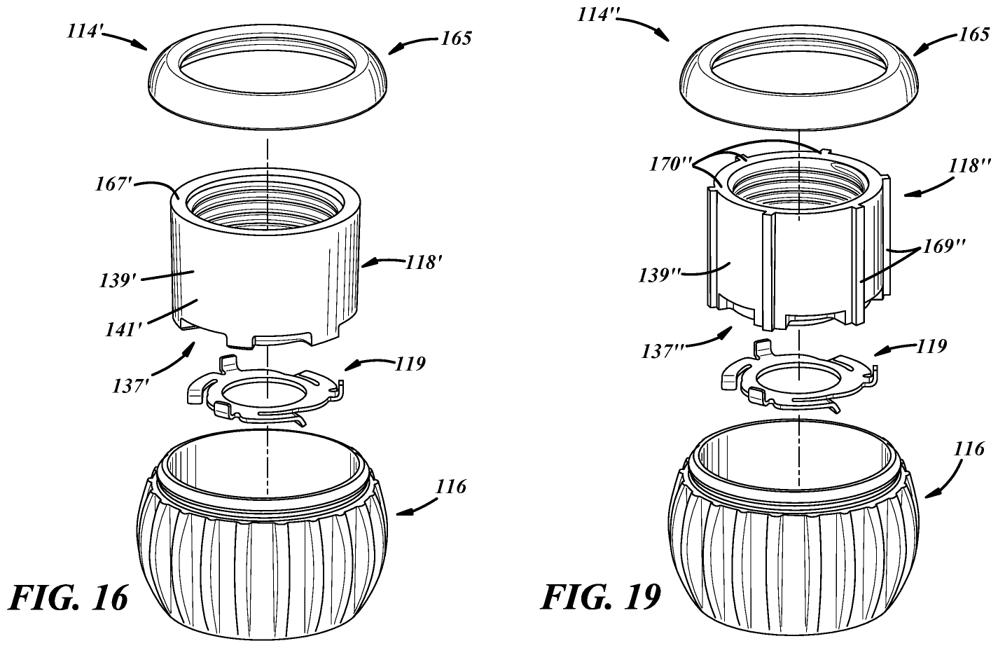

As best shown in FIG. 16, the driven nut 118′ of a first size includes a base wall 137′, a skirt 139′ extending axially away from the base wall 137′, having a smooth cylindrical outer surface 141′, and terminating in an annular end surface 167′. The driven nut 118′ also may include a hub 152′ (FIG. 15) having a hub extension 152a′ which is carried in a corresponding counterbore 168 (FIG. 15) of the drive shell 116. In this embodiment, the annular end surface 167′ is trapped by the cap 165.

In contrast, as best shown in FIG. 19, the driven nut 118″ of a second size includes a base wall 137″, a skirt 139″ extending axially away from the base wall 137″, having axially extending and radially outwardly projecting standoff ribs 169″, and terminating in a spoked end surface 170″. The driven nut 118″ also may include a hub 152″ (FIG. 18) carried in a corresponding counterbore 168 (FIG. 18) of the drive shell 116. In this embodiment, the spoked end surface 170″ is trapped by the cap 165.

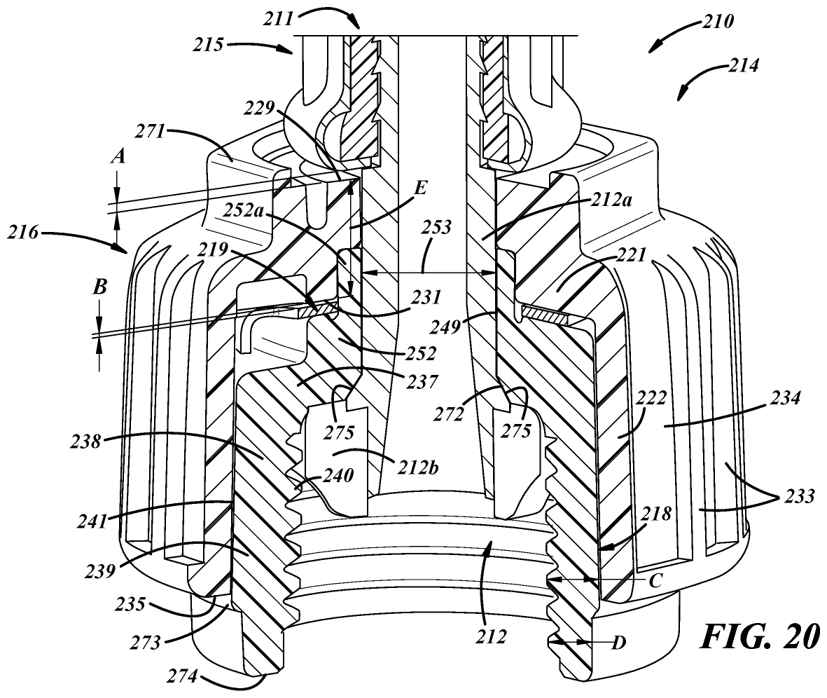

FIGS. 20-21 illustrate another illustrative embodiment of a torque-limiting nut adapted for use with differently sized driven nuts. This embodiment is similar in many respects to the embodiments of FIGS. 1-19 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

The following description of the torque-limiting nut will be described with reference to the embodiments of FIGS. 20-21, but it is understood that the description would be equally applicable to the other embodiments of FIGS. 1-19.

With reference to FIG. 20, a plumbing product 210 is shown and includes a braided hose 211, a barb and seal hose connector 212 having a barb 212a and seal 212b, a torque-limiting nut 214 trapped between the braided hose 211 and the barb and seal hose connector 212, and a ferrule 215 crimped around the braided hose 211 to the connector 212.

With continued reference to FIG. 20, the drive shell 216 carries the driven nut 218 and basically includes a shell base wall 221 and a shell skirt 222 extending axially outwardly from the shell base wall 221.

Similar to the abovementioned embodiments, the drive shell 216 may be of any suitable construction and composition. For example, the drive shell 216 may be molded from polymeric material, for instance, polypropylene or glass filled polypropylene. Or, the drive shell 216 may be manufactured from any other material and in any other manner suitable for use with torque-limiting nuts. So formed, two helpful clearances may exist. The first helpful clearance, clearance A, is disposed between the ferrule 215 and the hub 229 of the drive shell 216. The second helpful clearance, clearance B, is disposed between the drive shell 216 and the clutch 219. Clearances A and B may facilitate free rotation of the nut 214 relative to the rest of the product 210 and reduce an amount of deflection that beams 255 of the clutch 219 undergo from pocket to pocket during rotation of the nut 214. For example, the beams 255 may be configured to deflect 0.050″ from pocket to pocket and the sum of clearances A and B may be 0.010″ such that the amount of deflection of the beams 255 may be reduced from 0.050″ to 0.040″. Those of ordinary skill in the art will recognize that the particular parameter values and ranges disclosed herein may be suitable for use in a plumbing product environment, and that other parameter values and ranges may be used for other environments that may use differently sized components.

In any event, variation in the assembly of the product 210 due to manufacturing tolerances may be monitored to ensure that there are no worst case assembly stackups or build combinations that result in an excess clearance value that causes a lower than desired install torque limit value. The tradeoff for producing the product 210 to have a desirably low install torque value may be balanced with a goal that each and every assembled product achieves the minimum install torque value that ensures reliable long term sealing capability of the product 210. For example, for assemblies comprising clearances A or B, or both A and B, the maximum install torque required from a user will ideally be less than 2.5 Nm, but preferably between 1.4 Nm and 1.8 Nm. Therefore, it may be desirable to maintain variability of helpful clearances A and B within +0.001″ to 0.0125″ to reduce variability in the install torque limit value of each assembled product 210. The install torque limit value may be verified at the end of the assembly of each plumbing product 210 to ensure that each plumbing product 210 meets the minimum install torque necessary to ensure a reliable long-term seal. A method to verify the torque limit value is discussed in more detail below.

For embodiments involving passage of a hose, tube, pipe, wire, cable, or any other suitable component(s) through the drive shell 216 and the shell base wall 221. The drive shell 216 may include a hub 229 extending axially inwardly from the base wall 221 and establishing an aperture 228 via an internal diameter 230 of the hub 229. The drive shell 216 may also include a tool-engagement or auxiliary rim 271 extending axially inwardly from the base wall 221 and is spaced radially outward of the hub 229. In other embodiments, such as a cap nut (not shown), no aperture is needed.

The drive shell skirt 222 shown in FIG. 20 extends axially outward from the base wall 221, wherein an exterior of the drive shell skirt 222 dilates away from the central longitudinal axis 217 to an axial end 235. The drive shell skirt 222 may include knurling 233 on the exterior thereof, for example, for enhanced grip by a user. Contrary to known “wingnut” type ribs, the knurling 233 of the present embodiment is not tall enough or thick enough to result in pronounced warp. In practice, the knurling 233 allows an individual with arthritis in their hand to easily grip and apply 1.4 Nm to 2.5 Nm required to actuate the torque limit. There are instances, however, where installation and removal of plumbing products are challenging due to a tight surrounding environment. The auxiliary rim 271 may be received by various tools and wrenches to ease installation and removal in these situations. The exemplary embodiment shown in FIG. 20 depicts the auxiliary rim 271 as a hexagon with six wrench flats but may have more or less sides or flats depending on the specific application. The auxiliary rim 271 may also be round, triangular, rectangular, pentagonal, or any other shape known in the art that may be received by a tool or a wrench. Some common tools used to assist with installation and removal of plumbing products in tight environments include a pipe wrench, chain wrench, socket wrench, torque wrench, combination wrench, monkey wrench, strap wrench, pliers, and any other tools known in the art. Using a tool, such as a socket on hex, is known to help avoid cross threading plumbing products during installation. Notably, and contrary to other known plumbing products, the torque limiting features of the plumbing product described herein are designed for and permit the use of tools while avoiding the possibility of applying damaging excess torque to the nut or seal.

With continued reference to FIG. 20, the driven nut 218 may be of any suitable construction and composition. For example, the driven nut 218 may be molded from polymeric material, for instance, glass filled polypropylene. Or, the driven nut 218 may be manufactured from any other material and in any other manner suitable for use with torque-limiting nuts.

The driven nut 218 includes a base wall 237, a radially outer wall 238 extending axially outwardly from the base wall 237, and a hub 252 extending axially inwardly from the base wall having a hub extension 252a. The hub 252 and hub extension 252a establishing an aperture 249 via an internal diameter 253 of the hub 252.

As best shown in FIG. 20, the radially outer wall 238 is a skirt 239 that extends integrally from the base wall 237 and carries an internal thread 240. As used herein, the term “thread” includes one or more threads or thread segments. In addition, the base wall 237 and the radially outer wall 238 integrally form an internal shoulder 272. The internal shoulder 272 may be configured such that upon assembly, the barb 212a engages with the internal shoulder 272. The manner in which these components are assembled is discussed in greater detail below. In any case, the skirt 239 may have a substantially cylindrical body 241 that extends from the base wall 237 beyond the extent of the axial end 235 of the drive shell 216 to a first proximal region 273 at a thickness C. The skirt 239 may also continue to extend beyond the first axial region 273 to a second axial region 274 at a thickness D. In other words, the thickness of the skirt 239 may vary between the base wall 237 and the second axial region 274. The narrowing of the skirt 239 between the first axial region 273 and the second axial region 274 may help facilitate installation by accounting for interferences with other components in the surrounding environment.

With continued reference to FIG. 20, the drive shell may include lugs 231 which extend axially outward from the base wall 221 and are integral with a counterbore 268. As such, there exists an axial distance E between the hub 229 and the lugs 231 that is helpful to minimize variability of the axial position of the drive shell 216 relative to the driven nut 218. Maintaining the variability of axial distance E by less than 0.005″ may have a direct effect of reducing variability in the torque limit value.

With reference FIG. 21, the clutch or spring plate 219 of the illustrative embodiment of FIG. 20 is shown. The clutch 219 may be of any suitable construction and composition. For example, the clutch 219 may be stamped from metal, for instance, stainless steel, for example, 301 stainless steel. Or, the clutch 219 may be manufactured from any other material and in any other manner suitable for use with torque-limiting nuts.

The clutch 219 includes a plate 254, driven beams 255 extending radially outwardly and cantilevered with respect to the plate 254 and having legs 256 extending circumferentially and feet 257 extending circumferentially and axially inwardly at an oblique angle, and drive tangs 258 extending radially and axially outwardly with respect to the plate 254. The illustrative embodiment of the clutch 219 shown in FIG. 21 forgoes the use of support flanges which are introduced in abovementioned embodiments. There are two notable differences between the present illustrative embodiment shown in FIG. 20 and the illustrative embodiment shown in FIG. 15. First, the lugs 231 and hub 252 axially retain the clutch plate 254 to help combat any reaction forces that may have a tendency to tip the clutch 219 out of plane. Second, the hub extension 252a is axially longer than the hub extension 152a′ (FIG. 15) and engages with a portion of both the lugs 231 and the counterbore 268 which, by itself, may reduce variation in the torque limit of the torque limiting nut 214. One of ordinary skill in the art will recognize, however, the clutch 219, as shown, may still implement support flanges between the drive tangs 258 and the driven beams 255.

For embodiments involving passage of a hose, tube, pipe, wire, cable, or any other suitable component(s) through the clutch 219, the clutch 219 has an aperture 262 therethrough, wherein the driven beams 255 and the drive tangs 258 circumscribe the aperture 262. In other embodiments, such as a cap nut (not shown), no aperture is needed.

So formed and contrary to the abovementioned embodiments, the illustrative embodiment of FIG. 20 does not utilize a radially inwardly extending lip or a cap to axially trap the driven nut 218 between the drive shell base wall 221. Rather, the driven nut 218 is retained inside of the drive shell 216 between a flare 275 on the barb 212a and the crimped ferrule 215. The barb and seal hose connector 212 may be inserted through the aperture 249 of the driven nut 218 such that the circumferential flare 275 on the barb 212a engages with the internal shoulder 272 of the driven nut 218.

Even though the illustrative embodiment shown in FIG. 20 does not provide a radially inwardly extending lip or a cap as presented in the abovementioned embodiments, those of ordinary skill in the art will recognize that one or both features may still be included in the present embodiment. For example, a lip may still be produced by undercut molding, such that an annular groove on an expandible mold core may be used as an undercut to define the lip. In addition, those skilled in the art will recognize that a cap may be snap fit to the body of the drive shell 216 via interengaging annular features such as bayonet-style features (see, e.g., FIGS. 15 and 18 at 166a, 166b). Or, the cap may be removably coupled to the body via cooperating threads, or the like. In any case, the lip or cap may be provided to serve as seal or an additional axially trap to the driven nut 218.

As mentioned previously above, the lost motion shifting of the clutch allows the torque-limiting nut to provide a light install torque yet deliver significantly greater removal torque. For example, the torque-limiting nut may be coupled to the externally threaded component within an install torque limit range between 1 Nm and 2.5 Nm, including all ranges, sub-ranges, endpoints, and values in that range, for example, 1.3 Nm to 1.6 Nm. Conversely, the torque-limiting nut may be coupled to the externally threaded component within a removal torque limit range between 4 Nm and 6 Nm, including all ranges, sub-ranges, endpoints, and values in that range. Therefore, the install torque limit may be less than two and a half Nm and the removal torque limit may be greater than four times the install torque limit and, thus, the presently disclosed torque-limiting nut may provide superior performance over previously available products.

Certain use cases may involve several sequential install and removal cycles, particularly by inexperienced users, but, because of relatively low forces present during installation and creep resistant configuration of the clutch, the product may incur less degradation of an install torque limit after many cycles. For example, to provide good repeatability in performance, the torque-limiting nut may be configured such that it may be coupled to the externally threaded component with a drop off in install torque between 0.01 Nm and 0.3 Nm (including all ranges, sub-ranges, endpoints, and values in that range, for example, 0.1 Nm to 0.2 Nm) after five sequential install and removal cycles. Such performance is believed to be about three times better than that of currently available products.

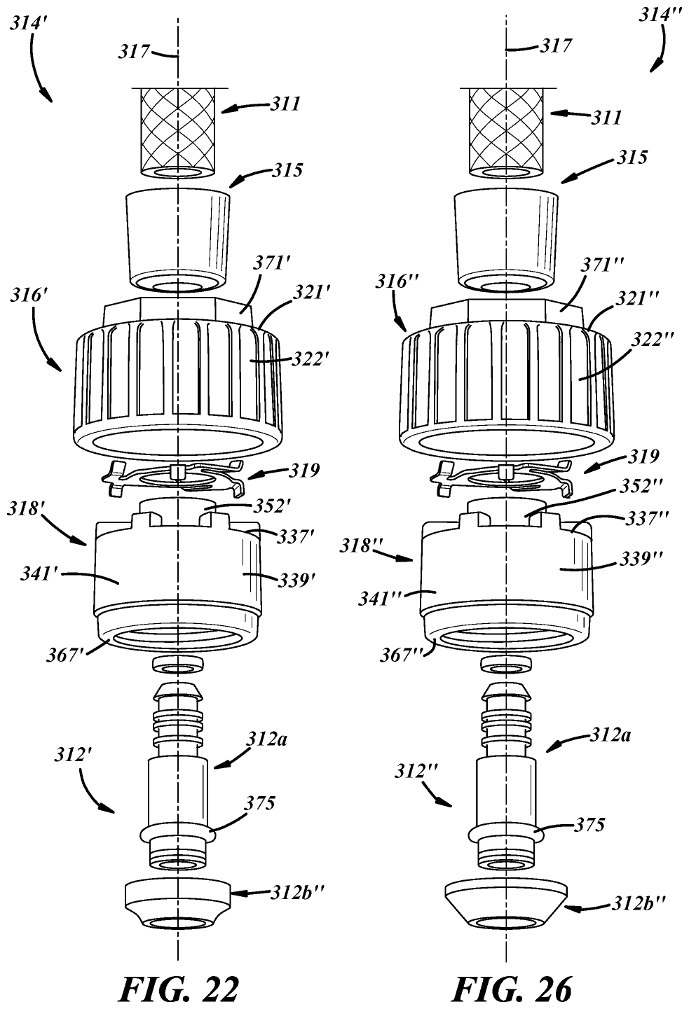

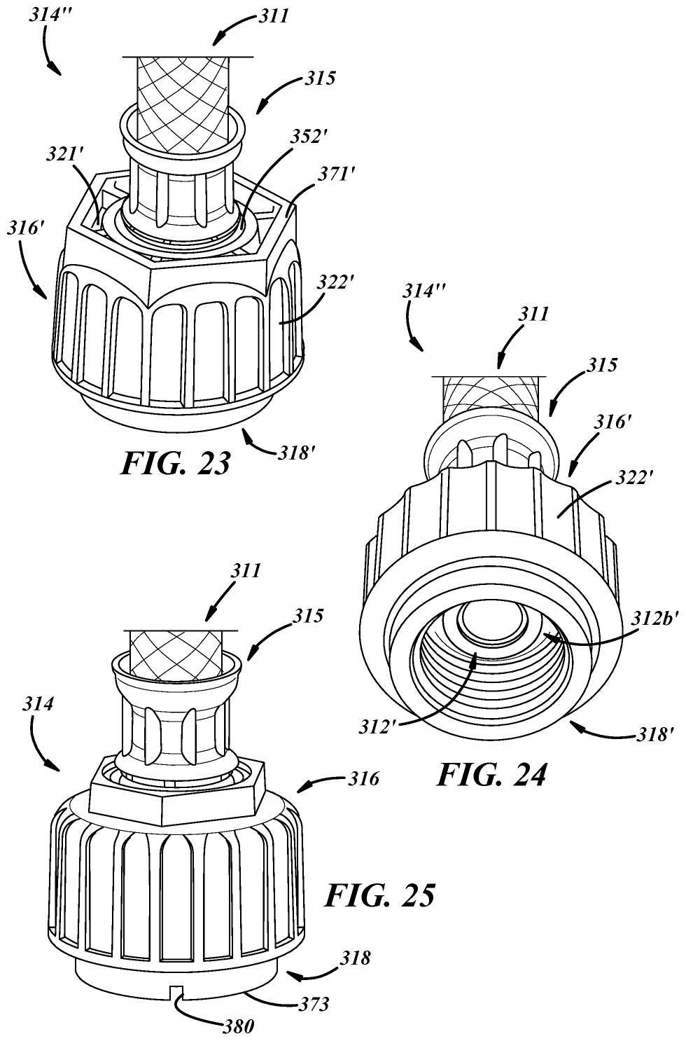

FIGS. 22-26 illustrate another illustrative embodiment of a torque-limiting nut adapted for use with differently sized driven nuts. This embodiment is similar in many respects to the embodiment of FIG. 20 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference to FIG. 22, a torque-limiting nut 314′ includes a drive shell of a first size 316′ rotatable about a central longitudinal axis 317, a driven nut of a first size 318′ configured to be carried in the drive shell 316′, and a spring plate or clutch 319 configured to be axially located between the drive shell 316′ and the driven nut 318′. The drive shell 316′ may include a base wall 321′, a skirt 322′ extending axially outward from the base wall 321′, and an auxiliary rim 371′ extending axially inward from the base wall 321′.

With continued reference to FIG. 22, a driven nut 318′ of a first size includes a base wall 337′, a skirt 339′ extending axially away from the base wall 337′, having a smooth cylindrical outer surface 341′, and terminating in an annular end surface 367′. The driven nut 318′ also may include a hub 352′ carried in a corresponding counterbore (not shown) of the drive shell 316′. The driven nut 318′ may be trapped in the drive shell 316′ on an outer axial end by a flare 375 on the barb 312a, wherein the flare 375 extends radially outward of the central longitudinal axis 317 and spans at least a portion of the circumference of the barb 312a and engages with an internal shoulder (not shown) of the driven nut 318′. A ferrule 315 may then be crimped to secure a braided hose 311 to the barb 312a and trap the driven nut 318′ on an inner axial end.

In contrast, as best shown in FIG. 26, a torque-limiting nut 314″ includes a drive shell of a second size 316″ rotatable about a central longitudinal axis 317, a driven nut of a second size 318″ configured to be carried in the drive shell 316″, and a spring plate or clutch 319 configured to be axially located between the drive shell 316″ and the driven nut 318″. The drive shell 316″ may include a base wall 321″, a skirt 322″ extending axially outward from the base wall 321″, and an auxiliary rim 371″ extending axially inward from the base wall 321″.

With continued reference to FIG. 26, a driven nut 318″ of a second size includes a base wall 337″, a skirt 339″ extending axially away from the base wall 337″, having a smooth cylindrical outer surface 341″, and terminating in an annular end surface 367″. The driven nut 318″ also may include a hub 352″ carried in a corresponding counterbore (not shown) of the drive shell 316″. The driven nut 318″ may be trapped in the drive shell 316″ on an outer axial end by a flare 375 on the barb 312a, wherein the flare 375 extends radially outward of the central longitudinal axis 317 and spans at least a portion of the circumference of the barb 312a and engages with an internal shoulder (not shown) of the driven nut 318″. A ferrule 315 may then be crimped to secure a braided hose 311 to the barb 312a and trap the driven nut 318′ on an inner axial end.

FIGS. 22 and 26 show illustrative embodiments that are substantially similar in design such that the same clutch plate 319 may used for the assembly of both of the different sized torque-limiting nuts 314′, 314″. In addition, while the same barb 312a may be used for the assembly of both torque-limiting nuts 314′, 314″, different hose seals 312b′, 312b″ may be utilized based on specific applications. For instance, the illustrative embodiment of FIG. 22 shows a tapered gasket seal 212b′ and the illustrative embodiment of FIG. 26 shows a seal 212b″ with a cone shape. Upon installation to another threaded component, the seals 212b′, 212b″ are compressed against the barb 312a and a portion of the driven nut 318′, 318″ to form a reliable long-term seal.

FIG. 25 shows a notch 380 at a proximal end 374 of the driven nut 318 which is designed so that torque can be applied between the driven nut 318 and drive shell 316 without having to thread a male mandrel into the nut 318. The notch 380 is used to verify the torque limit and that the torque limiting nut 314 was assembled properly.

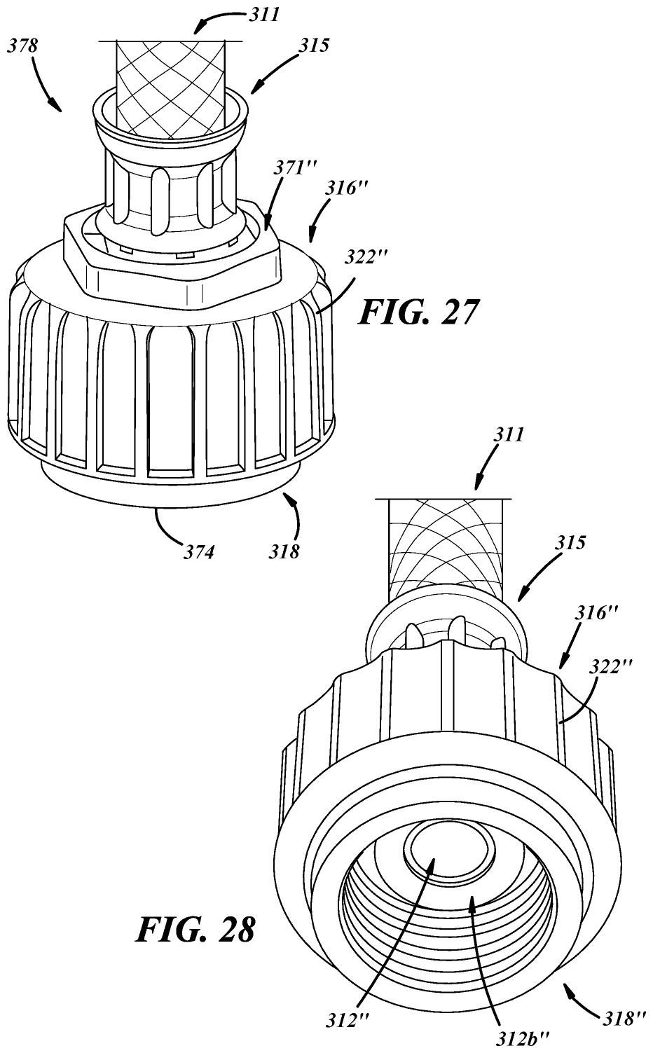

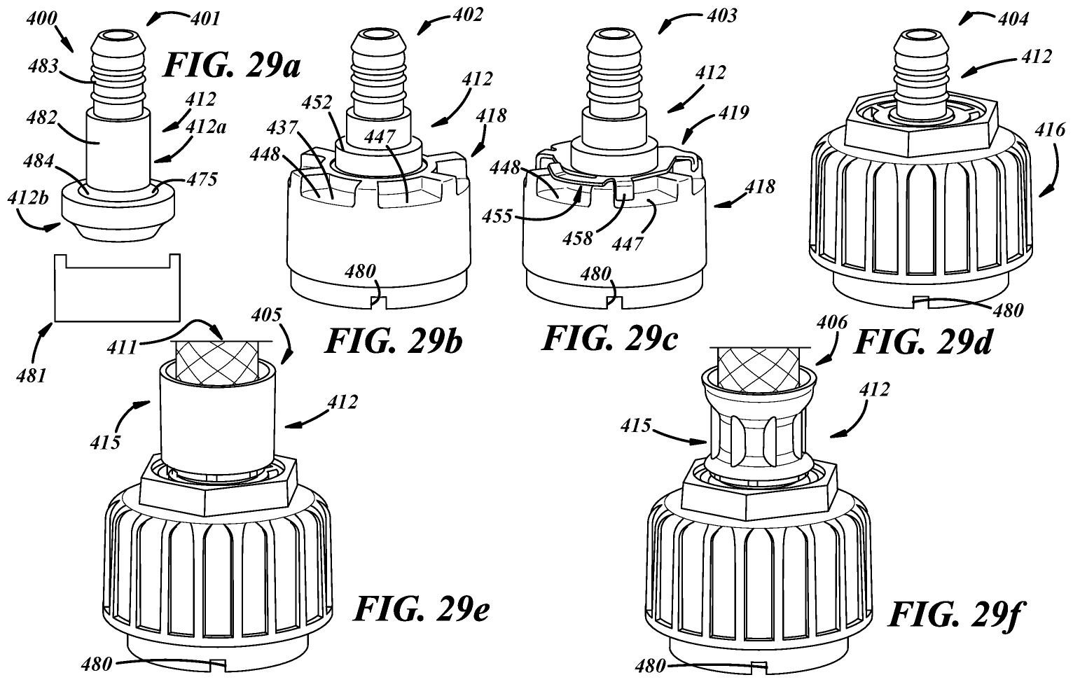

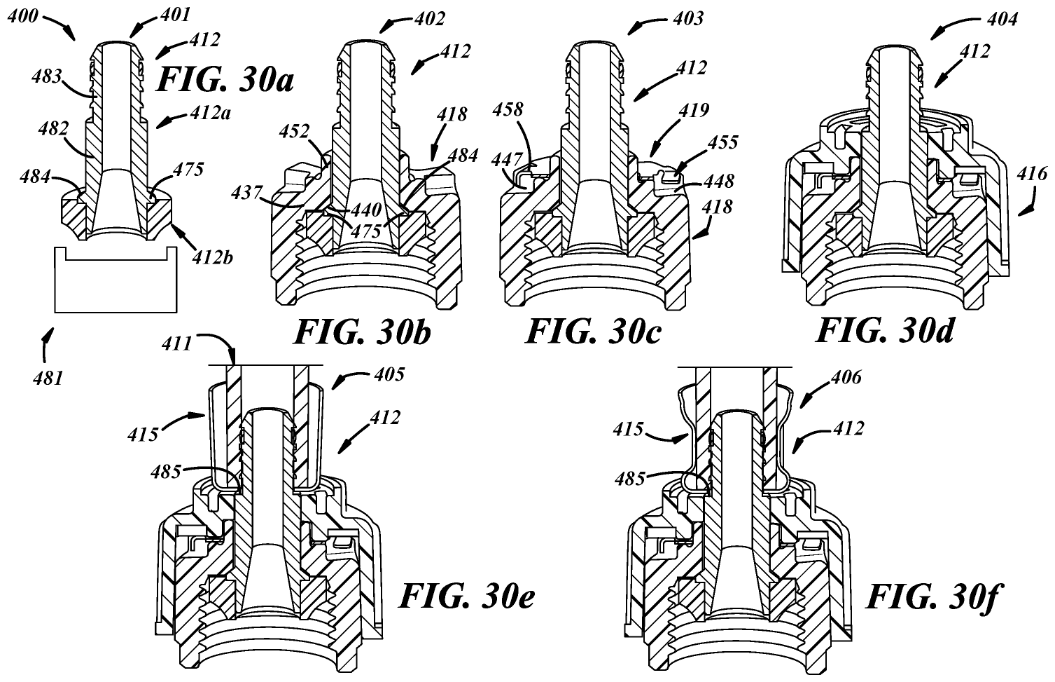

FIGS. 29 and 30 illustrate another illustrative embodiment of a torque-limiting nut being assembled via a nested assembly 400. This embodiment is similar in many respects to the embodiment of FIGS. 20-21 and FIGS. 22-28 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

Turning to FIGS. 29a-29f and 30a-30f, an illustrative embodiment of a method of a nested assembly 400 of a torque-limiting fastener 414 is shown. A nested assembly cell is provided and comprises a nest 481 and is designed for the assembly of the torque-limiting fastener 414, connecting a hose 411, and verifying the proper torque limit. Those of ordinary skill in the art will recognize that the nest 481 is shown merely schematically and only in FIGS. 29a and 30a, and that the nest 481 may be of any suitable shape, size, and configuration to frictionally engage the seal 412b and otherwise cooperate with other portions of the product.

In a first step 401, in FIGS. 29a and 30a, a barb and seal hose connector 412 is provided and is mounted in the nest 481. The connector 412 includes a rearward end having a base 482, a barb 412a, and a seal 412b, a forward end having a neck 483, and a flare 475 disposed circumferentially about the base 482 near the reward end defining a contact surface 484, and a longitudinal axis (not shown) extending between the rearward and forward ends.

In a second step 402, FIGS. 29b and 30b show a driven fastener 418 positioned over the forward end of the barb and seal hose connector 412, the driven fastener 418 having an internal shoulder 440 (FIG. 30b) which engages with the contact surface 484 (FIG. 30b) of the flare 475, the driven fastener 418 having a base wall 437 including forward-facing drive-tang pockets 447 (FIG. 29b), driven-on beam pockets 448 (FIG. 29b), and a hub 452. The driven fastener 418 may also comprise at least one notch 480 which is configured to mate with at least one corresponding tang of the nest 481. That way, it is not necessary to thread the driven fastener 418 to a threaded mandrel in order to torque test the assembled product.

In a third step 403, FIGS. 29c and 30c show a spring plate or clutch 419 positioned over the forward end of the barb and seal hose connector 412, the clutch 419 having driven beams 455 and drive tangs 458 that correspond with at least one of each of the drive-tang pockets 447 and the driven-on beam pockets 448.

In a fourth step 404, FIGS. 29d and 30d show a drive shell 416 positioned over the barb and seal hose connector 412 and trapping the clutch 419 between the drive shell 419 and the driven fastener 418.

In a fifth step 405, FIGS. 29e and 30e show the hose 411 being assembled to the barb and seal hose connector 412. The hose 411 may be assembled by first placing a ferrule 415 on the barb and seal hose connector 412 followed by pressing the hose 411 onto the hose connector 412b until the ferrule 415 is forced against a travel stop 485 (FIG. 30e) on the barb and seal hose connector 412.

In a sixth step 406, the ferrule 414 may be crimped around the hose 411 and the barb and seal hose connector 412. FIGS. 29f and 30f show the crimped ferrule 415 so that there is no gap between the ferrule 415 and the travel stop 485 (FIG. 30f) on the barb and seal hose connector 412. Torque limit variation of the torque-limiting fastener 414 is reduced as a result of there being no gap between the ferrule 415 and the travel stop 485 (FIG. 30f). Before the torque limiting fastener 414 is removed from the nest (not shown), the proper torque limit for the torque-limiting fastener may be verified.

One method of verifying the proper torque limit includes temporarily clamping or applying a force to the ferrule 415 in an axial direction toward the nest 481 and against the barb and seal hose connector 412, and then subsequently applying a torque to the drive shell 416 while the driven fastener 418 is held, for example, by tangs of the nest 481 (FIGS. 29a, 30a) via the notches 480 in the end of the fastener 418. The torque limit value for the assembly 400 may be calculated using the relationship between the torque applied to the drive shell 416 and the angular position of the drive shell 416. Preferably, the proper torque limit may be verified before the crimping step to help ensure that every product assembly meets the minimum install torque to ensure a reliable long term seal.

As mentioned at the outset, the presently disclosed innovations can be adapted for use with a torque-limiting bolt, which could be coupled to a component having an internal thread. Those of ordinary skill in the art would understand that a driven bolt would be substantially similar to the presently disclosed driven nuts, except instead of having a radially outer wall in the form of a cylindrical hollow skirt with internal threads, the driven bolt would have a cylindrical solid head and a threaded stud or shank extending away from the head. And, those of ordinary skill in the art would recognize that the driven bolt head could be adapted to include the driven-on surfaces and driven-off surfaces of the presently disclosed driven nuts. Also, the clutch would be carried on top of the driven bolt head with substantially the same structural and functional interrelationships as those presently disclosed herein with respect to the presently disclosed clutch and nuts. Additionally, an outer drive shell would be located over the driven bolt head with substantially the same structural and functional interrelationships as those presently disclosed herein with respect to the presently disclosed outer drive shells and nuts. And, of course, the clutch would be located between the outer drive shell and the driven bolt head with substantially the same structural and functional interrelationships as those presently disclosed herein with respect to the presently disclosed outer drive shells, clutches, and nuts. Additionally, a user would apply torque to the outer drive shell, which torque gets translated to the driven bolt head via the clutch. Such a design would allow installation of a bolt to a desired torque install value, wherein at least four times the torque install value is permitted to be applied to and carried through to the bolt head to remove the bolt where it may have become stuck due to corrosion, external deposits, system deformation, etc.

As used in this patent application, the terminology “for example,” “for instance,” “like,” “such as,” “comprising,” “having,” “including,” and the like, when used with a listing of one or more elements, is open-ended, meaning that the listing does not exclude additional elements. Likewise, when preceding an element, the articles “a,” “an,” “the,” and “said” mean that there are one or more of the elements. Moreover, directional words such as front, rear, top, bottom, upper, lower, radial, circumferential, axial, lateral, longitudinal, vertical, horizontal, transverse, and/or the like are employed by way of example and not limitation. As used herein, the term “may” is an expedient merely to indicate optionality, for instance, of an element, feature, or other thing, and cannot be reasonably construed as rendering indefinite any disclosure herein. Other terms are to be interpreted and construed in the broadest reasonable manner in accordance with their ordinary and customary meaning in the art, unless the terms are used in a context that requires a different interpretation.

Finally, the present disclosure is not a definitive presentation of an invention claimed in this patent application, but is merely a presentation of examples of illustrative embodiments of the claimed invention. More specifically, the present disclosure sets forth one or more examples that are not limitations on the scope of the claimed invention or on terminology used in the accompanying claims, except where terminology is expressly defined herein. And although the present disclosure sets forth a limited number of examples, many other examples may exist now or are yet to be discovered and, thus, it is neither intended nor possible to disclose all possible manifestations of the claimed invention. In fact, various equivalents will become apparent to artisans of ordinary skill in view of the present disclosure and will fall within the spirit and broad scope of the accompanying claims. Features of various implementing embodiments may be combined to form further embodiments of the invention. Therefore, the claimed invention is not limited to the particular examples of illustrative embodiments disclosed herein but, instead, is defined by one or more of the accompanying claims.

1. A torque-limiting fastener, comprising:
a drive shell, including
a shell base wall having
drive-off surfaces on an interior side of the shell base wall and facing a first circumferential direction, and
drive-on surfaces on the interior side of the shell base wall and facing a second circumferential direction, and
a shell skirt extending axially away from the shell base wall;
a driven fastener carried by the drive shell, and including
a fastener base wall having
driven-on surfaces on an exterior side of the fastener base wall and facing the first circumferential direction, and
driven-off surfaces on an exterior side of the fastener base wall and facing the second circumferential direction, and
a radially outer wall extending axially away from the fastener base wall; and
a clutch axially between the fastener and shell base walls, and including
a plate,
a driven beam extending radially outwardly and cantilevered with respect to the plate and having a leg extending circumferentially and a foot extending circumferentially and axially inwardly at an oblique angle, and
a drive tang extending radially and axially outward with respect to the plate.

2. The torque-limiting fastener of claim 1, wherein the shell skirt terminates in a radially inwardly extending lip.

3. The torque-limiting fastener of claim 2, wherein the driven fastener is axially trapped between the base wall and the radially inwardly extending lip.

4. The torque-limiting fastener of claim 1, wherein the driven fastener is axially trapped between the base wall and a cap that engages the shell skirt.

5. The torque-limiting fastener of claim 1, wherein the drive shell further includes a hub extending axially inwardly from the base wall and establishing the shell aperture via an internal diameter of the hub.

6. The torque-limiting fastener of claim 1, wherein the drive shell further includes an tool-engagement rim extending axially inwardly from the base wall and spaced radially outward of the hub.

7. The torque-limiting fastener of claim 1, wherein the shell drive-off surfaces extend substantially axially and the shell drive-on surfaces extend substantially obliquely.

8. The torque-limiting fastener of claim 1, wherein the driven fastener also includes drive tang pockets on an exterior side of the fastener base wall and circumferentially between the exterior driven-on and driven-off surfaces, and driven-on beam pockets on an exterior side of the fastener base wall and circumferentially interspersed with the drive tang pockets.

9. The torque-limiting fastener of claim 1, wherein the radially outer wall includes a substantially cylindrical body and terminates in a reverse-tapered flange.

10. The torque-limiting fastener of claim 1, wherein the fastener base wall includes clutch flange support lugs between the drive tang pockets and driven-on beam pockets and establishing the driven-off surfaces, clutch driven-on beam support lugs between the drive tang pockets and driven-on beam pockets and establishing the driven-on surfaces, and support flanges extending radially outwardly of the hub and circumferentially between the clutch drive tangs and the clutch driven beams.

11. The torque-limiting fastener of claim 10, wherein the clutch driven-on beam support lugs are circumferentially wider than the clutch flange support lugs.

12. The torque-limiting fastener of claim 10, wherein the drive tang pockets are axially deeper than the driven-on beam pockets.

13. A torque-limiting fastener of claim 1, wherein the radially outer wall of the driven fastener is integral with the base wall establishing an internal shoulder.

14. A torque-limiting fastener of claim 13, wherein the driven fastener is axially trapped on one axially end by a barb that contacts the internal shoulder and is axially trapped on a second axially end by a ferrule.

15. The torque-limiting fastener of claim 1, wherein the driven-on surfaces extend substantially axially and the driven-off surfaces extend substantially axially.

16. The torque-limiting fastener of claim 1, wherein the clutch drive tangs extend circumferentially between 2 and 10 angular degrees, the legs of the clutch driven beams extend circumferentially between 10 and 30 angular degrees, and the feet of the clutch driven beams extend at an oblique angle with respect to the legs between 20 and 70 angular degrees.

17. The torque-limiting fastener of claim 1, wherein the fastener is a lost motion assembly wherein the clutch is configured to cooperate with the drive shell and the driven fastener to provide a rotational delay between rotation of the drive shell and rotation of the driven fastener and to permit circumferential rotation of the clutch relative to the drive fastener.

18. The torque-limiting fastener of claim 1, wherein the shell skirt has no internal radial drive elements carried therein, and the driven fastener has no external radial driven elements carried thereon.

19. The torque-limiting fastener of claim 1, wherein the driven fastener is a driven nut.

20. A torque-limiting coupling assembly, comprising:
another threaded component having a thread; and
the torque-limiting fastener of claim 1 coupled to the other component, wherein the thread of the driven fastener is threaded to the thread of the other component.

21. The assembly of claim 20, wherein the torque-limiting fastener is coupled to the other component within an install torque limit range between 1 Nm and 2.5 Nm and within a removal torque limit range between 4 Nm and 6 Nm.

22. The assembly of claim 20, wherein the torque-limiting fastener is coupled to the other component with an install torque limit less than two Nm and with a removal torque limit greater than four times the install torque limit.

23. The assembly of claim 20, wherein the torque-limiting fastener is coupled to the other component with a drop off in install torque between 0.01 Nm and 0.3 Nm after five sequential install and removal cycles.

24. A torque-limiting drive shell, comprising:
a shell base wall, including
drive-off surfaces on an interior side of the shell base wall and facing a first circumferential direction and extending substantially axially, and
drive-on surfaces on an interior side of the shell base wall and facing a second circumferential direction and extending substantially obliquely; and
a shell skirt extending axially away from the shell base wall.

25. The drive shell of claim 24, wherein the shell base wall including a shell aperture, wherein the drive-off and drive-on surfaces circumscribe the shell aperture.

26. The drive shell of claim 24, further comprising a hub extending axially inwardly from the base wall and establishing the shell aperture via an internal diameter of the hub.

27. The drive shell of claim 24, further comprising a tool-engagement rim extending axially inwardly from the base wall and spaced radially outward of the hub.

28. The drive shell of claim 24, wherein the shell skirt terminates in a radially inwardly extending lip.

29. A torque-limiting driven fastener, comprising:
a fastener base wall, including
driven-on surfaces on an exterior side of the fastener base wall and facing in a first circumferential direction,
driven-off surfaces on an exterior side of the fastener base wall and facing in a second circumferential direction,
drive tang pockets on an exterior side of the fastener base wall and circumferentially between the exterior driven-on and driven-off surfaces, and
driven-on beam pockets on an exterior side of the fastener base wall and circumferentially interspersed with the drive tang pockets; and
a radially outer wall extending in an axial direction away from the fastener base wall.

30. The driven fastener of claim 29, wherein the radially outer wall is a fastener skirt carrying an internal thread, and the fastener base wall has a fastener aperture, and the driven-on and driven-off surfaces circumscribe the fastener aperture.

31. The driven fastener of claim 29, wherein the radially outer wall includes a substantially cylindrical body and terminates in a reverse-tapered flange.

32. The driven fastener of claim 29, wherein the fastener base wall includes clutch flange support lugs between the drive tang pockets and driven-on beam pockets and establishing the driven-off surfaces, and clutch driven-on beam support lugs between the drive tang pockets and driven-on beam pockets and establishing the driven-on surfaces.

33. The driven fastener of claim 32, wherein the clutch driven-on beam support lugs are circumferentially wider than the clutch flange support lugs.

34. The driven fastener of claim 29, wherein the drive tang pockets are axially deeper than the driven-on beam pockets.

35. The driven fastener of claim 29, wherein the radially outer wall is integral with the base wall and extends axially away from the fastener base wall.

36. The driven fastener of claim 29, wherein the housing skirt includes an external tapered surface that terminates in an external shoulder.

37. The driven fastener of claim 29, wherein the radially outer wall is integral with the base wall establishing an internal shoulder.

38. A torque-limiting clutch, comprising:
a plate;
driven beams extending radially outwardly and cantilevered with respect to the plate and having legs extending circumferentially and feet extending circumferentially and axially inwardly at an oblique angle; and
drive tangs extending radially and axially outwardly with respect to the plate.

39. The clutch of claim 38, further comprising support flanges extending radially outwardly of the plate and circumferentially between the drive tangs and the driven beams.

40. The clutch of claim 38, further comprising an aperture through the plate, wherein the driven beams and the drive tangs circumscribe the aperture.

41. The clutch of claim 38, wherein the drive tangs extend circumferentially between 2 and 10 angular degrees.

42. The clutch of claim 38, wherein the driven beams extend circumferentially between 10 and 30 angular degrees.

43. The clutch of claim 38, wherein the feet of the driven beams extend at an oblique angle with respect to the legs of the driven beams between 20 and 70 angular degrees.

44. A method for a nested assembly of a torque-limiting fastener comprising:
providing a barb and seal hose connector having a rearward end, a forward end having a neck and a flare extending about the neck, the flare defining a contact surface, and a longitudinal axis extending between the rearward and forward ends;
positioning a driven fastener over the forward end of the barb and seal hose connector, the driven fastener having an internal shoulder which engages with the contact surface of the flare, the driven fastener having a base wall including a drive-tang pocket, a driven-on beam pocket, and a hub;
positioning a clutch over the forward end of the barb and seal hose connector, the clutch having a driven beam and a drive tang that engage with at least one of each of the drive-tang pocket and the driven-on beam pocket;
positioning a drive shell over the forward end of the barb and seal hose connector; and
assembling a hose to the barb and seal hose connector.

45. A method according to claim 44, further comprising positioning the driven fastener, wherein the driven fastener comprises a notch that is designed to mate with an assembly nest to prevent rotation of the driven fastener during assembly.

46. A method according to claim 44, further comprising verifying the proper torque limit for the torque-limiting fastener.
